(19) United States
(12) Patent Application Publication
(10) Pub. No.: US 2026/0156550 A1
(43) Pub. Date: Jun. 4, 2026

(54) HANDOVER TO MOBILE IAB NODES

(71) Applicant: Telefonaktiebolaget LM Ericsson (publ), Stockholm (SE)

(72) Inventors: Magnus ÅSTRÖM, Lund (SE); Lei BAO, Göteborg (SE); Filip BARAC, Huddinge (SE); Boris DORTSCHY, Vendelsö (SE)

(21) Appl. No.: 18/706,558

(22) PCT Filed: Nov. 2, 2022
(86) PCT No.: PCT/EP2022/080510

§ 371 Date: May 1, 2024

Related U.S. Application Data
(60) Provisional application No. 63/274,644, filed on Nov. 2, 2021.

(51) Int. Cl. H04W 36/08

(52) U.S. Cl. CPC H04W 36/08

(57) ABSTRACT

Systems and methods are disclosed for handing over a User Equipment (UE) to a mobile Integrated Access and Backhaul network node (mIAB). A method performed by a network node for managing handover of a UE to a mIAB node includes obtaining a first parameter from the UE, and a second parameter from the mIAB node, wherein the first parameter and the second parameter are at least one of explicitly or implicitly related to a respective mobility of the UE and the mIAB node. The method further includes determining the UE is suitable for handover to the mIAB node, based at least in part on the first parameter and the second parameter. The method further includes configuring the UE to be handed over to the mobile IAB node.

### RELATED APPLICATIONS

This application claims the benefit of provisional patent application Ser. No. 63/274,644, filed Nov. 2, 2021, the disclosure of which is hereby incorporated herein by reference in its entirety.

### TECHNICAL FIELD

The present disclosure relates to a handover of a User Equipment (UE) in a wireless communications system, and more particularly, handing over a UE to a mobile integrated access and backhaul network node.

### BACKGROUND

### Intyergrated Access and Backhaul Overview

Densification via the deployment of increasing base stations (be them macro or micro base stations) is one of the mechanisms that can be employed to satisfy the ever-increasing demand for more and more bandwidth/capacity in mobile networks. Due to the availability of more spectrum in the millimeter wave (mmW) band, deploying small cells that operate in this band is an attractive deployment option for these purposes. However, deploying fiber to the small cells, which is the usual way in which small cells are deployed, can end up being very expensive and impractical. Thus, employing a wireless link for connecting the small cells to the operator's network is a cheaper and practical alternative with more flexibility and shorter time-to-market. One such solution is an Integrated Access and Backhaul (IAB) network, where the operator can utilize part of the radio resources for the backhaul link.

In FIG. 1, an IAB deployment that supports multiple hops is presented. The IAB donor node 102 (in short, “IAB donor”) has a wired connection to the core network and the IAB nodes 106 are wirelessly connected using NR to the IAB donor 102, either directly or indirectly via another IAB node (e.g., IAB node 104). The connection between IAB donor/node and User Equipments (UEs) 108-1, 108-2, and 108-3 is called “access link,” whereas the connection between two IAB nodes 104 and 106 or between an IAB donor 102 and an IAB node 104/106 is called “backhaul link.”

Furthermore, FIG. 2 illustrates terminologies of adjacent hops in the IAB network.

As shown in FIG. 2, the adjacent upstream node 202 which is closer to the IAB donor node of an IAB node 204 is referred to as a “parent node” of the IAB node. The adjacent downstream node 206 which is further away from the IAB donor node of an IAB node is referred to as a “child node” of the IAB node. The backhaul link between the parent node and the IAB node is referred to as “parent (backhaul) link,” whereas the backhaul link between the IAB node and the child node is referred to as “child (backhaul) link.”

### IAB Architecture

As one major difference of the IAB architecture compared to Rel-10 LTE relay (besides lower layer differences) is that the IAB architecture adopts the Central-Unit/Distributed-Unit (CU/DU) split of gNBs in which time-critical functionalities are realized in DU closer to the radio, whereas the less time-critical functionalities are pooled in the CU with the opportunity for centralization. Based on this architecture, an IAB-donor contains both CU and DU functions. In particular, it contains all CU functions of the IAB-nodes under the same IAB-donor. Each IAB-node then hosts the DU function(s) of a gNB. In order to be able to transmit/receive wireless signals to/from the upstream IAB-node or IAB-donor, each IAB-node has a mobile termination (MT), a logical unit providing a necessary set of UE-like functions. Via the DU, the IAB-node establishes RLC-channel to UEs and/or to MTs of the connected IAB-node(s). Via the MT, the IAB-node establishes the backhaul radio interface towards the serving IAB-node or IAB-donor. FIG. 3 shows a reference diagram for a two-hop chain of IAB-nodes 302 and 304 under an IAB-donor 306.

### IAB Topologies

Wireless backhaul links are vulnerable to blockage, e.g., due to moving objects such as vehicles, due to seasonal changes (foliage), severe weather conditions (rain, snow, or hail), or due to infrastructure changes (new buildings). Such vulnerability also applies to IAB-nodes. Also, traffic variations can create uneven load distribution on wireless backhaul links leading to local link or node congestion. In view of those concerns, the IAB topology supports redundant paths as another difference compared to the Rel-10 LTE relay.

The following topologies are considered in IAB as shown in FIG. 4: Spanning tree (ST) 402 and Directed Acyclic Graph (DAG) 404. In FIG. 4, the arrow indicates the directionality of the graph edge, which means that one IAB node can have multiple child nodes and/or have multiple parent nodes. The multi-connectivity or route redundancy may be used for back-up purposes. It is also possible that redundant routes are used concurrently, e.g., to achieve load balancing, reliability, etc.

### Mobile IAB T

hird Generation Partnership Project (3GPP) is discussing whether RAN nodes should be deployed on moving objects like car or busses. Such deployment would allow to quickly extend coverage. This would be necessary, if, for example, connectivity inside a vehicle is reduced or because of high losses through coated and therefore EM shielding windows and/or shielding metal elements. Another use case for RAN nodes deployed on moving objects is to provide connectivity to UEs that are in the vicinity of the mobility enabled node and move along with it.

### SUMMARY

Systems and methods are disclosed for handing over a UE to a mobile integrated access and backhaul network node. In one embodiment, a method performed by a network node for managing handover of a User Equipment (UE) to a mobile Integrated Access and Backhaul (mIAB) node comprises obtaining at least one first parameter related to mobility of the UE and at least one second parameter related to mobility of the mIAB node. The method further comprises determining that the UE is suitable for handover to the mobile IAB node, based at least in part on the at least one first parameter and the at least one second parameter. The method further comprises configuring the UE to be handed over to the mIAB node.

In another embodiment, a network node is configured to manage handover of a UE to a mIAB node, and the network node includes a radio interface and processing circuitry that is configured to obtain at least one first parameter related to mobility of the UE and at least one second parameter related to mobility of the mIAB node. The processing circuitry is also configured to determine that the UE (502) is suitable for handover to the mIAB node, based at least in part on the at least one first parameter and the at least one second parameter. The processing circuitry is also configured to configure the UE to be handed over to the mIAB node.

In another embodiment a non-transitory computer-readable medium is provided that includes computer-readable instructions, that when executed by a processor, perform operations. The operations include obtaining at least one first parameter related to mobility of a UE and at least one second parameter related to mobility of a mIAB, node. The operations further include determining (606) that the UE is suitable for handover to the mIAB node, based at least in part on the at least one first parameter and the at least one second parameter. The operations further include configuring the UE to be handed over to the mobile IAB node

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is an exemplary illustration of a multi-hop deployment in an integrated access and backhaul network according to one or more embodiments.

FIG. 2 is an exemplary illustration of an integrated access and backhaul architecture of a parent node and a child node according to one or more embodiments.

FIG. 3 is an exemplary illustration of a two-hop chain of integrated access and backhaul nodes according to one or more embodiments.

FIG. 4 is an exemplary illustration of examples of topologies in an integrated access and backhaul network according to one or more embodiments.

FIG. 5 is an exemplary illustration of a system configuration for handing over a User Equipment (UE) to a mobile integrated access and backhaul network node according to one or more embodiments.

FIG. 6 is a flowchart of a method for handing over a UE to a mobile integrated access and backhaul network node according to one or more embodiments.

FIG. 7 is an exemplary illustration of a table containing parameter relations for both the UE and the mIAB according to one or more embodiments.

FIG. 8 shows an example of a communication system 800 in accordance with some embodiments.

FIG. 9 shows a UE 900 in accordance with some embodiments.

FIG. 10 shows a network node 1000 in accordance with some embodiments

FIG. 11 is a block diagram of a host according to one or more embodiments.

FIG. 12 is a block diagram illustrating a virtualization environment.

FIG. 13 is block diagram of a host according to one or more embodiments.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). The present technology does not support mobile network nodes. Hence, the present technology does not consider the problem of performing handover to a mobile network node. It is currently discussed whether mobile Integrated Access and Backhaul (IAB) nodes should be specified in Third Generation Partnership Project (3GPP). For handovers towards such nodes, the legacy handover procedure may not be preferable since it does not prevent stationary User Equipments (UEs) from connecting to mobile IAB nodes. Consequently, when the mobile IAB node moves on, potentially, a large amount of stationary UEs may need to simultaneously change their serving cells (e.g., to the cells served by static network nodes) to maintain network connectivity. In order to avoid potential network storms in higher layers resulting from such simultaneous handover requests, there is a need for a method that only allows mobile UEs to connect to the mobile IAB node in the first place.

Certain aspects of the disclosure and their embodiments may provide solutions to these or other challenges. The present disclosure is directed to a network node for managing handover of a UE to a mobile Radio Access Network (RAN) node, in general, and a mobile IAB-node, in particular. The difference compared to legacy handover is that proximity or channel quality alone is not a suitable measure for allowing handover to a mobile RAN/IAB node. In addition, the IAB node and the UE should also share mobility properties, e.g., channel quality or proximity during mobility. This may be achieved by assessing doppler spread, timing or other measures in addition to Reference Symbol (or Signal) Received Power (RSRP) or Reference Symbol (or Signal) Received Quality (RSRQ), and only after they are determined to match that of the mobile IAB node, is the UE handed over to the mobile IAB node.

Certain embodiments may provide one or more of the following technical advantage(s). The advantage with the proposed method of the present disclosure is that it allows for reliable handover to mobile IAB nodes for suitable (co-mobile) UEs without risking ill-suited (stationary or non-co-mobile) UEs to be handed over to the mobile RAN node. Consequently, there is an improved end-user experience by improved handover for suitable UEs and reduced erroneous handover for ill-suited UEs.

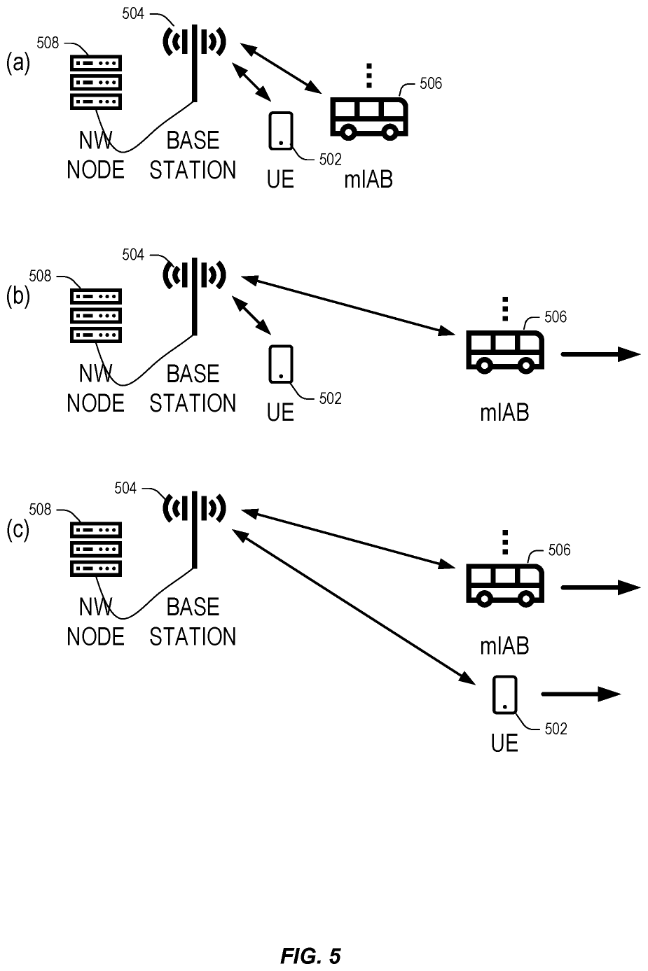

FIG. 5 illustrates a system configuration of the present disclosure. In (a) of FIG. 5, a UE 502 is connected to a base station 504, but may also receive signals from (and connect to) a mobile IAB (mIAB) node 506. In (b), the UE 502 remains close to the base station 504 while the mIAB node 506 moves away and should hence not connect to the mIAB node 506, whereas in (c), the UE 502 moves away together with the mIAB node 506 and should hence connect to the mIAB node 506.

The present disclosure relates to a UE 502 or a device that is connected to a stationary base station or stationary IAB node (network node) 504. The base station 504 may in turn be connected to another network node 508, which can be an IAB donor node. A UE 502 is connected to the base station 504 and furthermore, a mIAB node 506 may be connected to said base station 504 or another base station. The UE 502 is sufficiently close to the mIAB node 506 to be within its coverage, e.g., to receive its sync signals or other signals. Upon departure of the mIAB node 506, the following two outcomes from the UE 502 perspective, are desirable: (a) If the UE 502 moves along with the mIAB node 506, the UE 502 should be handed over to or associated with the mIAB node 506; (b) If the UE 502 does not move along with the mIAB node 506, the UE 502 should not be handed over to or associated with the mIAB node 506.

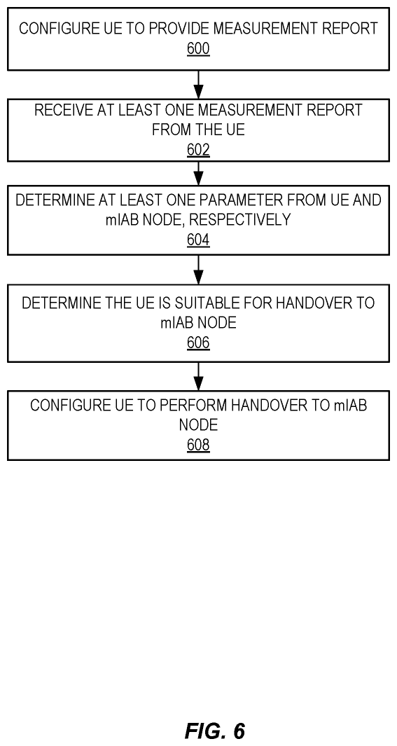

FIG. 6 is a flow chart of an exemplary embodiment of the present disclosure. The present disclosure discloses an example of a method in a first network node for managing handover for a device (UE) between a network node (e.g., a gNB or an IAB-DU), and a mobile IAB (mIAB-DU) node. The first network node may be the same or a separate node compared to the network node.

In a first step (600) of FIG. 6, the first network node configures the UE to perform and report measurements. Such measurements may be UE-specific or MT-specific, or they may be cell-specific, i.e., restricted to a cell that is related to the mIAB node, or unrestricted, i.e., performed on cells as determined by the UE. The configuration and reporting may optionally, e.g., take place on an Uu (i.e., the air) interface that is established between the first network node and the UE. Alternatively, if the network node 508 is a central unit (CU), the CU does not have an air interface, (e.g., does not have a physical PHY layer for physical Tx/Rx) but only a logical connection.

The present disclosure discloses an example of a method in a first network node for managing handover for a device (e.g., a UE) between a network node (e.g., a gNB or an IAB-DU), and a mobile IAB (mIAB-DU) node. The UE is connected to the network node and is potential candidate for handover to mIAB. The first NW is moderator. The UE is connected to network node (which is potentially the first network node). In case the first network node is a CU, the connection between CU and UE is on RRC level and the physical links are established via, e.g., fiber and Uu from a DU.

In a second step (602), the first network node receives at least one measurement report from the UE, related to the mIAB node.

In a third step (604), the first network node determines at least one parameter from the UE and mIAB node, respectively. The at least one parameter may be related to mobility, e.g., Doppler spread, timing advance, or Global Positioning System (GPS)-based mobility information. These parameters may either be measured by the first network node or provided by one or more other network nodes, and, in order to determine whether the UE should connect to the mIAB node, the evaluation of the below criteria is done when the mIAB node is moving, where, in one variant, the mIAB node explicitly indicates to the first network node that it has started to move, and in another variant, the first network node determines by itself that the mIAB has started moving. It should be realized that if the UE and mIAB node are associated with different network nodes (e.g., different donor nodes 508 or stationary IAB nodes 504) during the determinations, timing advance (TA) values may differ, however the frequency of the TA or the accumulated absolute TA values over time are likely to be similar.

In a fourth step (606), the first network node determines that the UE should be handed over to the mIAB node. The determination may be based on one or more of the following requirements are met:
(a) The at least one UE measurement report indicates an RSRP or RSRQ, or other signal strength or signal quality metric of the mIAB node above a threshold.
(b) The estimated Doppler spread of both the UE and mIAB node exceeds a first threshold.
(c) The difference in estimated Doppler spread between the UE and mIAB node is below a second threshold.
(d) The estimated timing advance including the frequency with which timing advance commands are provided to both the UE and the mIAB node exceeds a third threshold.
(e) The difference in estimated timing advance or frequency with which timing advance commands are provided to both the UE and mIAB node is below a fourth threshold.
(f) The distance between the UE and an mIAB node is determined to be constant (based on e.g., GPS information), while the distance to other static network nodes in the area is changing.

In short, if both UE and mIAB are determined to be mobile and share the same mobility pattern and the UE is receiving from the mIAB cell sufficiently well, the UE can be handed over to the mIAB node. One or more of the above parameters may instead be used in a trained Artificial Intelligence/Machine Learning (AI/ML) network (or algorithm) to determine whether UE handover to the mIAB node is suitable or not. The above AI/ML network (or algorithm) may reside in the first network node and/or in the UE, and/or in the mIAB node.

In a fifth step (608), the first network node configures the UE to be handed over to the mIAB node.

In an embodiment related to the first step (600) and the second step (602), the first network node may also configure the mIAB node to perform measurements on neighboring cells in order to identify a preferred network node for the UE 502 to associate with and/or for it to assess and/or report mobility conditions of the mIAB node.

In one embodiment, in case the UE is capable of dual connectivity, handover may be performed such that the UE is in a first step configured to be dually connected to the stationary network node and the mIAB node, and in a second step, the UE is released from the stationary network node. In one embodiment, the stationary network node and mIAB node act as the Master Network node (MN) and Secondary Network node (SN), respectively, in the DC configuration. In another embodiment, the stationary network node and mIAB can switch the roles (MN vs SN) in the DC configuration.

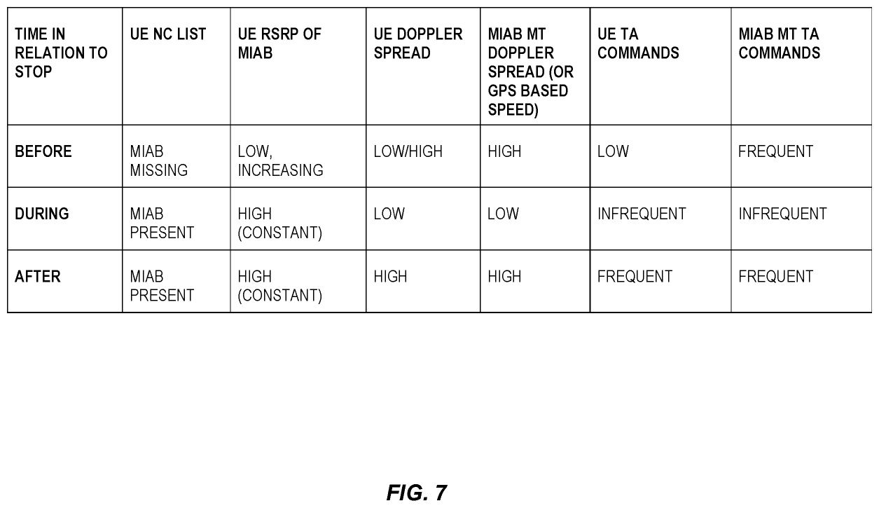

FIG. 7 shows a table containing parameter relations for both the UE and the mIAB node in case they share mobility pattern, i.e., the UE is on board at the same vehicle as the mIAB node.

### Additional Description

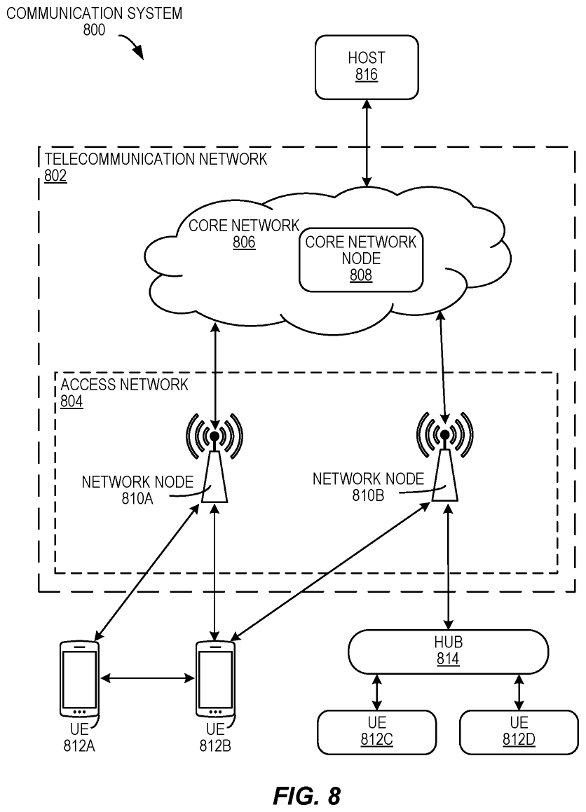

FIG. 8 shows an example of a communication system 800 in accordance with some embodiments.

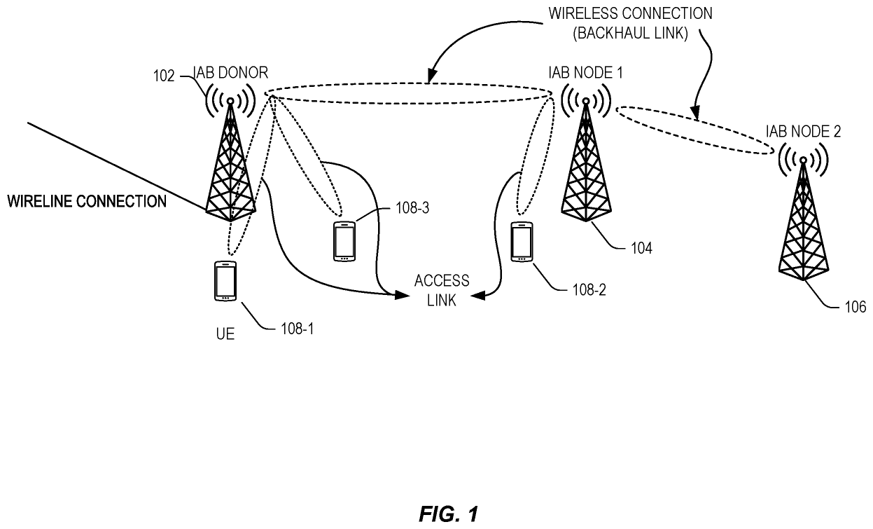

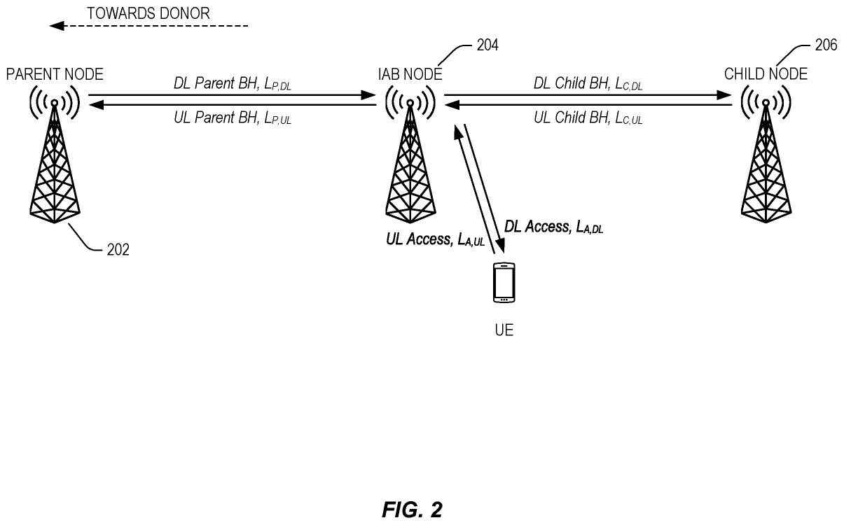

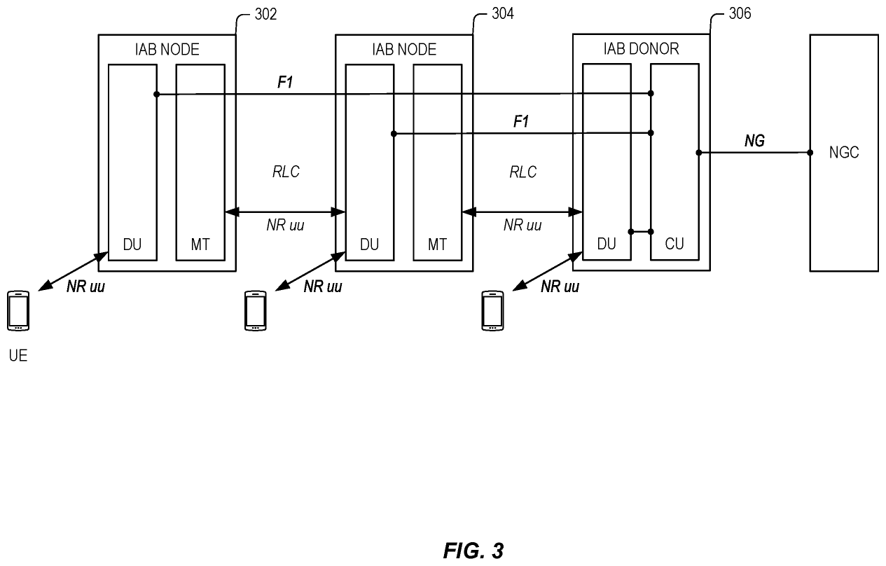

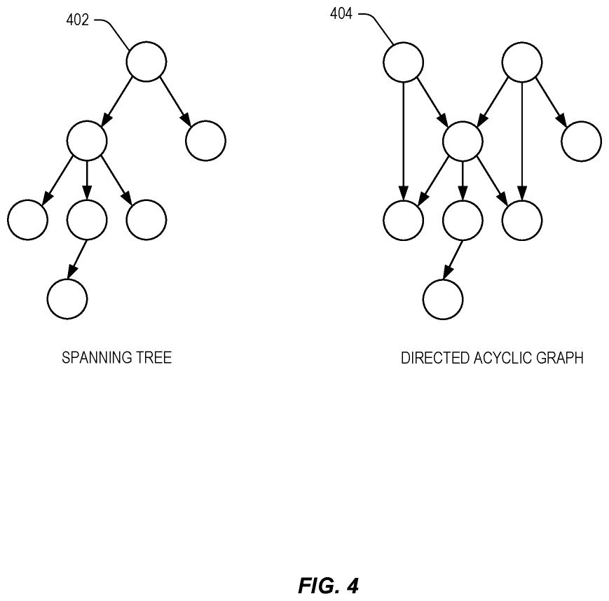

In the example, the communication system 800 includes a telecommunication network 802 that includes an access network 804, such as a Radio Access Network (RAN), and a core network 806, which includes one or more core network nodes 808. The access network 804 includes one or more access network nodes, such as network nodes 810A and 810B (one or more of which may be generally referred to as network nodes 810), or any other similar 3GPP access node or non-3GPP Access Point (AP). The network nodes 810 facilitate direct or indirect connection of UE, such as by connecting UEs 812A, 812B, 812C, and 812D (one or more of which may be generally referred to as UEs 812) to the core network 806 over one or more wireless connections. Examples of the network nodes 800 are the IAB donor 102, the IAB node 1 104, and the IAB node 2 106 in FIG. 1; the parent node 202, the IAB node 204, and the child node 206 in FIG. 2; the IAB node 302, the IAB node 304, and the IAB donor 306 in FIG. 3; the network node 508, base station 504 and mIAB node 506 in FIG. 5. The UE 812 corresponds to the UEs 108 in FIG. 1; the UE in FIG. 2; the UE in FIG. 3; and the UE 502 in FIG. 5.

Example of wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system 800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 802 is a cellular network that implements 3GPP standardized features. Accordingly, the telecommunication network 802 may support network slicing to provide different logical networks to different devices that are connected to the telecommunication network 802. For example, the telecommunication network 802 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single-or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a Virtual Reality (VR) headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to a Machine-to-Machine (M2M) service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub-that is, a hub whose primary function is to route communications to/from the UEs from/to the network node 810B. In other embodiments, the hub 814 may be a non-dedicated hub-that is, a device which is capable of operating to route communications between the UEs and the network node 810B, but which is additionally capable of operating as a communication start and/or end point for certain data channels.

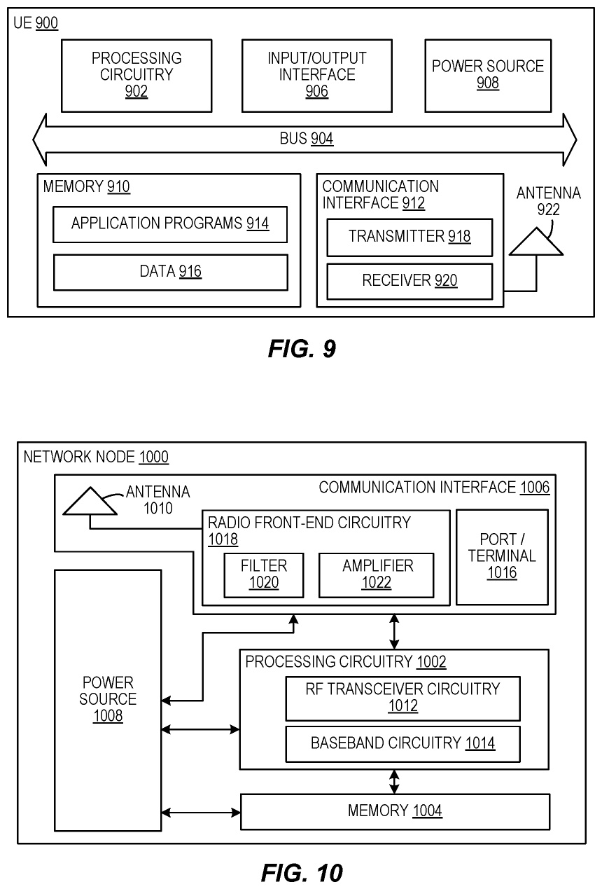

FIG. 9 shows a UE 900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 902 may include multiple Central Processing Units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack.

Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging the power source 908. Power circuitry may perform any formatting, converting, or other modification to the power from the power source 908 to make the power suitable for the respective components of the UE 900 to which power is supplied.

The memory 910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 910 may allow the UE 900 to access instructions, application programs, and the like stored on transitory or non-transitory memory media, to off-load data, or to upload data. An article of manufacture, such as one utilizing a communication system, may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., the antenna 922) and may share circuit components, software, or firmware, or alternatively be implemented separately.

In the illustrated embodiment, communication functions of the communication interface 912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 912, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 10 shows a network node 1000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes processing circuitry 1002, memory 1004, a communication interface 1006, and a power source 1008. The network node 1000 may be composed of multiple physically separate components (e.g., a Node B component and an RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1000 may be configured to support multiple RATs. In such embodiments, some components may be duplicated (e.g., separate memory 1004 for different RATs) and some components may be reused (e.g., an antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1000.

The processing circuitry 1002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1000 components, such as the memory 1004, to provide network node 1000 functionality.

In some embodiments, the processing circuitry 1002 includes a System on a Chip (SOC). In some embodiments, the processing circuitry 1002 includes one or more of Radio Frequency (RF) transceiver circuitry 1012 and baseband processing circuitry 1014. In some embodiments, the RF transceiver circuitry 1012 and the baseband processing circuitry 1014 may be on separate chips (or sets of chips), boards, or units, such as radio units and digital units. In alternative embodiments, part or all of the RF transceiver circuitry 1012 and the baseband processing circuitry 1014 may be on the same chip or set of chips, boards, or units.

The memory 1004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and the memory 1004 are integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. The radio front-end circuitry 1018 comprises filters 1020 and amplifiers 1022. The radio front-end circuitry 1018 may be connected to the antenna 1010 and the processing circuitry 1002. The radio front-end circuitry 1018 may be configured to condition signals communicated between the antenna 1010 and the processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of the filters 1020 and/or the amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface 1006 may comprise different components and/or different combinations of components.

In certain alternative embodiments, the network node 1000 does not include separate radio front-end circuitry 1018; instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes the one or more ports or terminals 1016, the radio front-end circuitry 1018, and the RF transceiver circuitry 1012 as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, the communication interface 1006, and/or the processing circuitry 1002 may be configured to perform any receiving operations and/or certain obtaining operations described herein as being performed by the network node 1000. Any information, data, and/or signals may be received from a UE, another network node, and/or any other network equipment. Similarly, the antenna 1010, the communication interface 1006, and/or the processing circuitry 1002 may be configured to perform any transmitting operations described herein as being performed by the network node 1000. Any information, data, and/or signals may be transmitted to a UE, another network node, and/or any other network equipment.

The power source 1008 provides power to the various components of the network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid or an electricity outlet) via input circuitry or an interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

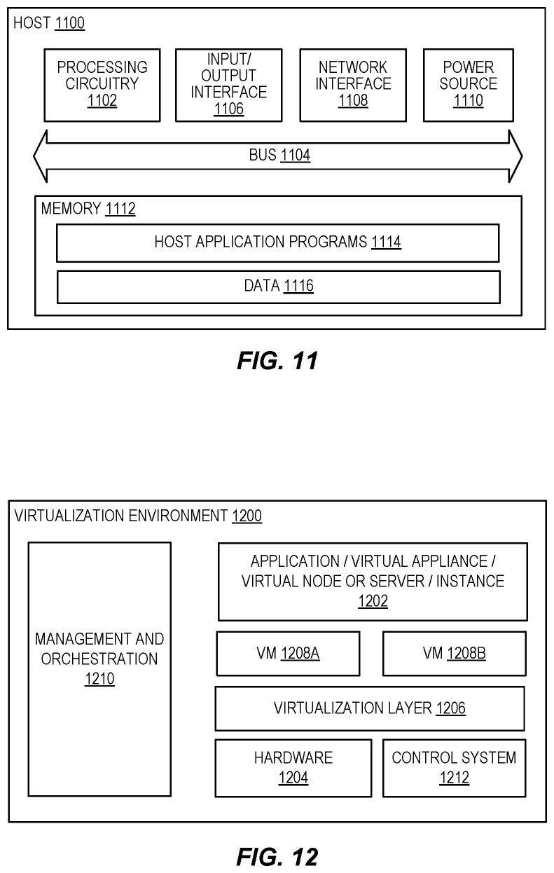

FIG. 11 is a block diagram of a host 1100, which may be an embodiment of the host 816 of FIG. 8, in accordance with various aspects described herein. As used herein, the host 1100 may be or comprise various combinations of hardware and/or software including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and memory 1112. Other components may be included in other embodiments. Features of these components may be substantially similar to those described with respect to the devices of previous figures, such as FIGS. 9 and 10, such that the descriptions thereof are generally applicable to the corresponding components of the host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for Over-The-Top (OTT) services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or VM Monitors (VMMs)), provide VMs 1208A and 1208B (one or more of which may be generally referred to as VMs 1208), and/or perform any of the functions, features, and/or benefits described in relation with some embodiments described herein. The virtualization layer 1206 may present a virtual operating platform that appears like networking hardware to the VMs 1208.

The VMs 1208 comprise virtual processing, virtual memory, virtual networking, or interface and virtual storage, and may be run by a corresponding virtualization layer 1206. Different embodiments of the instance of a virtual appliance 1202 may be implemented on one or more of the VMs 1208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1208 may be a software implementation of a physical machine that runs programs as if they were executing on a physical, non-virtualized machine. Each of the VMs 1208, and that part of the hardware 1204 that executes that VM, be it hardware dedicated to that VM and/or hardware shared by that VM with others of the VMs 1208, forms separate virtual network elements. Still in the context of NFV, a virtual network function is responsible for handling specific network functions that run in one or more VMs 1208 on top of the hardware 1204 and corresponds to the application 1202.

The hardware 1204 may be implemented in a standalone network node with generic or specific components. The hardware 1204 may implement some functions via virtualization. Alternatively, the hardware 1204 may be part of a larger cluster of hardware (e.g., such as in a data center or CPE) where many hardware nodes work together and are managed via management and orchestration 1210, which, among others, oversees lifecycle management of the applications 1202. In some embodiments, the hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1212 which may alternatively be used for communication between hardware nodes and radio units.

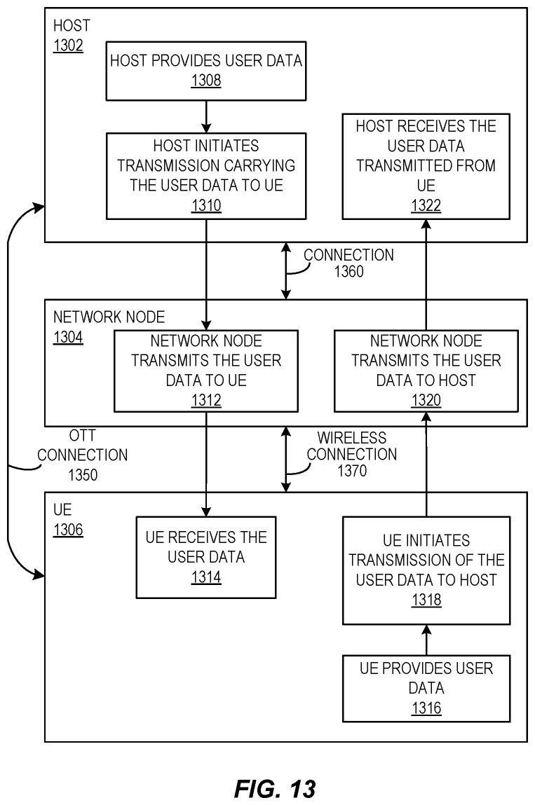

FIG. 13 shows a communication diagram of a host 1302 communicating via a network node 1304 with a UE 1306 over a partially wireless connection in accordance with some embodiments. Example implementations, in accordance with various embodiments, of the UE (such as the UE 812A of FIG. 8 and/or the UE 900 of FIG. 9), the network node (such as the network node 810A of FIG. 8 and/or the network node 1000 of FIG. 10), and the host (such as the host 816 of FIG. 8 and/or the host 1100 of FIG. 11) discussed in the preceding paragraphs will now be described with reference to FIG. 13.

Like the host 1100, embodiments of the host 1302 include hardware, such as a communication interface, processing circuitry, and memory. The host 1302 also includes software, which is stored in or is accessible by the host 1302 and executable by the processing circuitry. The software includes a host application that may be operable to provide a service to a remote user, such as the UE 1306 connecting via an OTT connection 1350 extending between the UE 1306 and the host 1302. In providing the service to the remote user, a host application may provide user data which is transmitted using the OTT connection 1350.

The network node 1304 includes hardware enabling it to communicate with the host 1302 and the UE 1306 via a connection 1360. The connection 1360 may be direct or pass through a core network (like the core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by the UE 1306 and executable by the UE's processing circuitry. The software includes a client application, such as a web browser or operator-specific “app” that may be operable to provide a service to a human or non-human user via the UE 1306 with the support of the host 1302. In the host 1302, an executing host application may communicate with the executing client application via the OTT connection 1350 terminating at the UE 1306 and the host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via the connection 1360 between the host 1302 and the network node 1304 and via a wireless connection 1370 between the network node 1304 and the UE 1306 to provide the connection between the host 1302 and the UE 1306. The connection 1360 and the wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304 in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR, or AR which it can broadcast, multicast, or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1350 between the host 1302 and the UE 1306 in response to variations in the measurement results. The measurement procedure and/or the network functionality for reconfiguring the OTT connection 1350 may be implemented in software and hardware of the host 1302 and/or the UE 1306. In some embodiments, sensors (not shown) may be deployed in or in association with other devices through which the OTT connection 1350 passes; the sensors may participate in the measurement procedure by supplying values of the monitored quantities exemplified above, or by supplying values of other physical quantities from which software may compute or estimate the monitored quantities. The reconfiguring of the OTT connection 1350 may include message format, retransmission settings, preferred routing, etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency, and the like by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Embodiments

Embodiment 1: A method performed by a first network node for managing handover of a User Equipment, UE, to a mobile Integrated Access and Backhaul, mIAB, node, the method comprising: configuring (FIGS. 6, 600) the UE to provide a measurement report on a cell related to the mIAB node; receiving (FIGS. 6, 602) at least one measurement report from the UE; determining (FIGS. 6, 604) at least one parameter from the UE and mIAB node, respectively; determining (FIGS. 6, 606) the UE is suitable for handover to the mobile IAB node; and configuring (FIGS. 6, 608) the UE to be handed over to the mobile IAB node.

Embodiment 2: The method of embodiment 1 wherein the first network node is a donor node or a donor Central Unit, CU.

Embodiment 3: The method of any of embodiments 1 or 2 wherein the determined at least one parameter is either measured by the first network node or received from another network node.

Embodiment 4: The method of embodiment 3 wherein the at least one parameter provides an indication of mobility.

Embodiment 5: The method of embodiment 4 wherein the at least one parameter is related to one or more of (a) Doppler spread and (b) timing advance command meta data.

Embodiment 6: The method of any of embodiments 1 to 5 wherein the UE is determined to be suitable for handover if one or more of the following applies: (a) the at least one measurement report indicates Reference Signal Received Power (RSRP) or Reference Signal Received Quality (RSRQ) above a threshold; (b) Doppler spread of both the UE and mIAB-Mobile-Termination, MT, exceeds a threshold; (c) a difference in Doppler spread between the UE and the IAB-MT is below a threshold; (d) both of estimated timing advances of the UE and mIAB-MT exceed a threshold; (e) a difference in timing advance between the UE and the mIAB-MT is below a threshold; and (f) a distance between the UE and an mIAB node is (approximately) constant, while the distance to other static network nodes in the area is changing.

Embodiment 7: The method of any of embodiments 1 to 6 wherein determining the UE is suitable for handover is performed by Artificial Intelligence, AI, or Machine Learning, ML, network.

Embodiment 8: The method of any of embodiments 1 to 7 wherein the UE is a dual-connection, DC, capable UE, the method further comprising: configuring a dual connection to the UE, including the mIAB node; and releasing the dual connection to the first network node.

Embodiment 9: The method of any of the previous embodiments, further comprising: providing user data; and forwarding the user data to a host via the transmission to the network node.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AI Artificial Intelligence
AMF Access and Mobility Function
AN Access Network
AP Access Point
ASIC Application Specific Integrated Circuit
AUSF Authentication Server Function
CPU Central Processing Unit
CU Central Unit
DC Dual Connection
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IAB Integrated Access and Backhaul
IoT Internet of Things
IP Internet Protocol
LTE Long Term Evolution
mIAB mobile Integrated Access and Backhaul
ML Machine Learning
MME Mobility Management Entity
MN Master Network
MSC Mobile Switching Center
MT Mobile Termination
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RSRP Reference Symbol or Signal Received Power
RSRQ Reference Symbol or Signal Received Quality
RTT Round Trip Time
SCEF Service Capability Exposure Function
SMF Session Management Function
SN Secondary Network
TA Timing Advance
UDM Unified Data Management
UE User Equipment
UPF User Plane Function
VR Virtual Reality

Those skilled in the art will recognize improvements and modifications to the embodiments of the present disclosure. All such improvements and modifications are considered within the scope of the concepts disclosed herein.

1. A method performed by a network node for managing handover of a User Equipment (UE) to a mobile Integrated Access and Backhaul (mIAB) node, the method comprising:
obtaining at least one first parameter related to mobility of the UE and at least one second parameter related to mobility of the mIAB node;
determining that the UE is suitable for handover to the mobile IAB node, based at least in part on the at least one first parameter and the at least one second parameter; and
configuring the UE to be handed over to the mIAB node.

2. The method of claim 1, wherein the network node is an IAB donor or a donor Central Unit (CU).

3. The method of claim 1, wherein the obtaining further comprises:
configuring the UE to provide a measurement report on a cell related to the mIAB node;
receiving at least one measurement report from the UE; and
determining the at least one first parameter based on the measurement report.

4. The method of claim 1, wherein the at least one first parameter is either measured by the network node or received from another network node.

5. The method of claim 1, wherein the at least one second parameter is either measured by the network node or received from another network node.

6. The method of claim 1, wherein the at least one first parameter and the at least one second parameter are related to one or more of (a) Doppler spread and (b) timing advance command meta data.

7. The method of claim 1, wherein determining that the UE is suitable for handover to the mobile IAB node comprises determining that the UE is suitable for handover to the mobile IAB node based on a triggering condition comprising one or more of:
(a) at least one measurement report received from the UE indicates Reference Signal Received Power (RSRP) or Reference Signal Received Quality (RSRQ) above a threshold RSRP;
(b) a Doppler spread of both the UE and an mIAB-Mobile Termination (MT) of mIAB node exceeds a first threshold Doppler spread;
(c) a difference in Doppler spread between the UE and the IAB-MT is below a second threshold Doppler spread;
(d) both of estimated timing advances of the UE and the mIAB-MT exceed a threshold timing advance (e) a difference in timing advance between the UE and the mIAB-MT is below a threshold timing advance difference; and
(f) a distance between the UE and the mIAB node is changing less than a distance of the UE to another static network node in the area is changing.

8. The method of claim 1, wherein determining that the UE is suitable for handover to the mIAB node is performed by an Artificial Intelligence (AI) or Machine Learning (ML) network.

9. The method of claim 1, wherein the UE is a dual-connection (DC) capable UE, and the method further comprises: configuring a dual connection between the UE and another network node; and releasing the dual connection between the UE and the mIAB node.

10. A network node configured to manage handover of a User Equipment (UE) to a mobile Integrated Access and Backhaul (mIAB) node, the network node comprising a radio interface and processing circuitry configured to cause the network node to:
obtain at least one first parameter related to mobility of the UE and at least one second parameter related to mobility of the mIAB node;
determine that the UE is suitable for handover to the mIAB node, based at least in part on the at least one first parameter and the at least one second parameter; and
configure the UE to be handed over to the mIAB node.

11. The network node of claim 10, wherein the network node is an IAB donor or a donor Central Unit (CU).

12. The network node of claim 10, wherein in order to obtain the at least one first parameter, the processing circuitry is further configured to cause the network node to:
configure the UE to provide a measurement report on a cell related to the mIAB node;
receive at least one measurement report from the UE; and
determine the at least one first parameter based on the measurement report.

13. The network node of claim 10, wherein the at least one first parameter is either measured by the network node or received from another network node.

14. The network node of claim 10, wherein the at least one second parameter is either measured by the network node or received from another network node

15. The network node of claim 10, wherein the at least one first parameter and the at least one second parameter are related to one or more of (a) Doppler spread and (b) timing advance command meta data.

16. The network node of claim 10, wherein the UE is determined to be suitable for handover to the mIAB node based on a triggering condition comprising one or more of:
(a) at least one measurement report received from the UE indicates Reference Signal Received Power (RSRP) or Reference Signal Received Quality (RSRQ) above a threshold RSRP;
(b) a Doppler spread of both the UE and an mIAB-Mobile-Termination (MT), MT, of mIAB node exceeds a first threshold Doppler spread;
(c) a difference in Doppler spread between the UE and the IAB-MT is below a second threshold Doppler spread;
(d) both of estimated timing advances of the UE and the mIAB-MT exceed a threshold timing advance;
(e) a difference in timing advance between the UE and the mIAB-MT is below a threshold timing advance difference; and
(f) a distance between the UE and the mIAB node is changing less than a distance of the UE to another static network node in the area is changing.

17. The network node of claim 10, wherein determining the UE is suitable for handover is performed by an Artificial Intelligence (AD) or Machine Learning (ML) network.

18. The network node of claim 10, wherein the UE is a dual-connection (DC) capable UE, and the processing circuitry is further configured to cause the network node to:
configure a dual connection between the UE and the mIAB node; and
release the dual connection between the UE and the network node

19. A non-transitory computer-readable medium comprising computer-readable instructions, that when executed by a processor of a network node, cause the network node to perform operations comprising:
obtaining at least one first parameter related to mobility of a User Equipment (UE) and at least one second parameter related to mobility of a mobile Integrated Access and Backhaul (mIAB) mIAB, node;
determining that the UE is suitable for handover to the mIAB node, based at least in part on the at least one first parameter and the at least one second parameter; and
configuring the UE to be handed over to the mIAB node.
